(19) United States
(12) Patent Application Publication
(10) Pub. No.: US 2025/0263597 A1
(43) Pub. Date: Aug. 21, 2025

(54) NOVEL CORROSION INHIBITION PACKAGE

(71) Applicant: Fluid Energy Group Ltd., Calgary (CA)

(72) Inventors: Adam Selig, Calgary (CA); Tom McLoughlin, Foothills (CA)

(21) Appl. No.: 19/053,973

(22) Filed: Feb. 14, 2025

(30) Foreign Application Priority Data
Feb. 16, 2024 (CA) 3229497
May 3, 2024 (CA) 3237363

(51) Int. Cl. C09K 8/54; C09K 8/74

(52) U.S. Cl. CPC C09K 8/54; C09K 8/74; C09K 2208/32

(57) ABSTRACT

An inhibition corrosion package for use with an acidic composition, where the package includes a terpene component; a propargyl alcohol or derivative thereof; optionally, a tall oil fatty acid; at least one amphoteric surfactant; and a solvent. Also disclosed are acidic compositions combining the corrosion inhibition package for use in various industrial operations including, but not limited to, oil and gas operations. Also disclosed are methods of using such compositions.

### CROSS REFERENCE TO RELATED APPLICATIONS

The subject application claims priority to Canadian Application No. 3,229.497 filed Feb. 16, 2024, and to Canadian Application No. 3,237,363 filed May 3, 2024, the contents of each application incorporated by reference in their entirety.

### FIELD OF THE INVENTION

This invention relates to corrosion inhibition packages for use with acidic compositions, more specifically to corrosion inhibition packages for use with acidic composition wherein said package comprises a thiourea organic derivative, tall oil fatty acids and at least one amphoteric surfactant.

### BACKGROUND OF THE INVENTION

In the oil & gas industry, stimulation with an acid is performed on a well to increase or restore production. In some instances, a well initially exhibits low permeability, and stimulation is employed to commence production from the reservoir. In other instances, stimulation or remediation is used to further encourage permeability and flow from an already existing well that has become under-productive.

Acidizing is a type of stimulation treatment which is performed above or below the reservoir fracture pressure in an effort to restore or increase the natural permeability of the reservoir rock. Acidizing is achieved by pumping acid into the well to dissolve typically limestone, dolomite and calcite cement between the sediment grains of the reservoir rocks or to treat scale accumulation.

There are three major types of acid applications: matrix acidizing, fracture acidizing, and breakdown acidizing (pumped prior to a fracturing pad or cement operation in order to assist with formation breakdown (reduce fracture pressures, increased feed rates), as well as clean up left over cement in the well bore or perforations. A matrix acid treatment is performed when acid is pumped into the well and into the pores of the reservoir formation below the fracture pressure. In this form of acidization, the acids dissolve the sediments formation and/or mud solids that are inhibiting the permeability of the rock, enlarging the natural pores of the reservoir (wormholing) and stimulating flow of hydrocarbons to the wellbore. While matrix acidizing is done at a low enough pressure to keep from fracturing the reservoir rock, fracture acidizing involves pumping highly pressurized acid into the well, physically fracturing the reservoir rock and etching the permeability inhibitive sediments. This type of acid treatment forms channels or fractures through which the hydrocarbons can flow, in addition to forming a series of wormholes. In some instances, a proppant is introduced into the fluid which assists in propping open the fractures, further enhancing the flow of hydrocarbons into the wellbore.

There are many different mineral and organic acids used to perform an acid treatment on wells. The most common type of acid employed on wells to stimulate production is hydrochloric acid (HCl), which is useful in stimulating carbonate reservoirs.

Some of the major challenges faced in the oil & gas industry from using hydrochloric acid include the following: extremely high levels of corrosion (which is countered by the addition of ‘filming’ type corrosion inhibitors that are typically themselves toxic and harmful to humans, the environment and equipment) reactions between acids and various types of metals can vary greatly but softer metals, such as aluminum and magnesium, are very susceptible to major effects causing immediate damage. Hydrochloric acid produces Hydrogen chloride gas which is toxic (potentially fatal) and corrosive to skin, eyes and metals. At levels above 50 ppm (parts per million) it can be Immediately Dangerous to Life and Health (IDHL). At levels from 1300-2000 ppm death can occur in 2-3 minutes.

The inherent environmental effects (organic sterility, poisoning of wildlife etc.) of acids in the event of an unintended or accidental release on surface or downhole into water aquifers or other sources of water are devastating which can cause significant pH reduction of such and can substantially increase the toxicity and could potentially cause a mass culling of aquatic species and potential poisoning of humans or livestock and wildlife exposed to/or drinking the water. An unintended release at surface can also cause a hydrogen chloride gas cloud to be released, potentially endangering human and animal health. This is a common event at large storage sites when tanks split or leak. Typically if near the public, large areas need to be evacuated post event and a comprehensive, expensive to implement, emergency evacuation plan need to be in place prior to approval of such storage areas. Because of its acidic nature, hydrogen chloride gas is also corrosive, particularly in the presence of moisture.

The inability for acids and blends of such to biodegrade naturally without neutralizing the soil results in expensive cleanup-reclamation costs for the operator should an unintended release occur. Moreover, the toxic fumes produced by mineral & some organic acids are harmful to humans/animals and are highly corrosive and/or produce potentially explosive vapours. Transportation and storage requirements for acids are restrictive and taxing in such that you must haul the products in acid approved tankers or intermediate bulk containers (IBC) that are rated to handle such corrosive products. As well, the dangers surrounding exposure by personnel handling the blending of such corrosive/dangerous products limits their use/implementation.

Another concern is the potential for exposure incidents on locations due to high corrosion levels of acids causing storage container failures and/or deployment equipment failures i.e. coiled tubing or fracturing iron failures caused by high corrosion rates (pitting, cracks, pinholes and major failures). Other concerns include: downhole equipment failures from corrosion causing the operator to have to execute a work-over and replace down hole pumps, tubing, cables, packers etc.; inconsistent strength or quality level of mineral & organic acids; potential supply issues based on industrial output levels; high levels of corrosion on surface pumping equipment resulting in expensive repair and maintenance levels for operators and service companies; the requirement of specialized equipment that is purpose built to pump acids greatly increasing the capital expenditures of operators and service companies; and the inability to source a finished product locally or very near its end use; transportation and onsite storage difficulties.

Extremely high corrosion and reaction rates with temperature increase causes conventional acids to “spend/react or become neutral” prior to achieving its desired effect such as deeply penetrating an oil or gas formation to increase the wormhole or etched “pathway” effectively to allow the petroleum product to flow freely to the wellbore. As an example, hydrochloric acid can be utilized in an attempt to free stuck drill pipe in some situations. Prior to getting to the required depth to dissolve the formation that has caused the pipe/tubing to become stuck many acids spend or neutralize due to increased bottom hole temperatures and greatly increased reaction rate, so it is advantageous to have an alternative that spends or reacts more methodically allowing the slough to be treated with a solution that is still active, allowing the pipe/tubing to be pulled free.

When used to treat scaling issues on surface due to water contamination, conventional acids are exposed to human and mechanical devices as well as expensive pumping equipment causing increased risk for the operator and corrosion effects that damage equipment and create hazardous fumes. When mixed with bases or higher pH fluids, acids will create a large amount of thermal energy (exothermic reaction) causing potential safety concerns and equipment damage, acids typically need to be blended with fresh water (due to their intolerance of highly saline water, causing potential precipitation of minerals) to the desired concentration requiring companies to pre-blend off-site as opposed to blending on-site with field/produced water thereby increasing costs associated with transportation.

Conventional mineral acids used in a pH control situation can cause rapid degradation of certain polymers/additives requiring increased loadings or chemicals to be added to counter these negative effects. Many offshore areas of operations have very strict regulatory rules regarding the transportation/handling and deployment of acids causing increased liability and costs for the operator. When using an acid to pickle tubing or pipe, very careful attention must be paid to the process due to high levels of corrosion, as temperatures increase, the typical additives used to control corrosion levels in acid systems begin to degrade very quickly (due to the inhibitors “plating out” on the steel) causing the acids to become very corrosive and resulting in damage to downhole equipment/tubulars. Conventional acids are also very destructive to most elastomers found in the oil & gas industry such as those found in blow out preventers (BOP's)/downhole tools/packers/submersible pumps/seals etc. Having to deal with spent acid during the back flush process is also very expensive as these acids typically are still at a low pH and remain toxic. It is advantageous to have an acid blend that can be exported to production facilities through pipelines that, once spent or applied, is much higher than that of spent HCl, reducing disposal costs/fees.

Acids perform many actions in the oil & gas industry and are considered necessary to achieve the desired production of various petroleum wells, maintain their respective systems and aid in certain drilling operational functions (i.e. freeing stuck pipe, filter cake treatments). The associated dangers that come with using mineral acids are expansive and tasking to mitigate through controls whether they are chemically or mechanically engineered.

Eliminating or even simply reducing the negative effects of acids while maintaining their usefulness is a struggle for the industry. As the public demand for the use of cleaner/safer/greener products increases, companies are looking for alternatives that perform the required function without all or most of the drawbacks associated with the use of conventional acids.

Modified and synthetic acids developed and currently patented are aimed at increasing personnel safety, reducing corrosion effects, reducing environmental damage, retarding the reaction rate and reducing the toxicity profile of HCl. However, it has been found that at temperatures above 90° C. the urea component in a synthetic or modified acid containing such compound tends to ultimately decompose to ammonia and carbon dioxide. The ammonia component will neutralize the acidic component or HCl and render the product non-reactive or neutral. Additionally, there is the risk of wellbore and/or formation damage due to uncontrolled solubilized mineral precipitation due to an increase in the pH caused mainly by the formation of ammonia during the decomposition phase. The advent of newer synthetic or modified acids is intended on providing usage at higher temperatures while still maintaining the performance, safety and environmental advantages and benefits of a urea-HCL modified or synthetic acid system. However, ultimately at these higher temperatures it is most often necessary to utilize additional or purpose developed corrosion inhibition packages and/or components to control corrosion of exposed steel. In that respect, even short exposure times at high temperature are more damaging to steel than longer exposure times at lower temperatures. In keeping with the changing times, there is also a strong desire to develop corrosion packages which are more “environmentally friendly and more effective” than conventional packages.

EP patent application 1 724 375 A2 discloses an aqueous organic acid composition containing a terpene as corrosion inhibitor intensifier said to be especially suitable for use in acidizing subterranean formations and wellbores. The composition is said to substantially reduce the corrosive effects of the acidic solution on metals in contact with the acidic solution. Suitable terpenes are said to include carotene, limonene, pinene, farnesene, camphor, cymene and menthol.

U.S. Pat. No. 8,765,021 teaches an aqueous treatment composition for inhibiting corrosion and acid attack on metallic surfaces that comprises a thiourea organic derivative, a polyalkoxylated terpene nonionic surfactant and an acid. The invention also relates to a process for cleaning industrial metallic equipment, in particular heat exchangers in which a heat transfer fluid, generally based on air or on water, flows, with a view to cleaning them and removing scale and other soiling.

US patent application no. 2003/0166472 discloses a well treatment microemulsion that is formed by combining a solvent-surfactant blend with a carrier fluid. In preferred embodiments, the solvent-surfactant blend includes a surfactant and a solvent selected from the group consisting of terpenes and alkyl or aryl esters of short chain alcohols. The disclosed well treatment microemulsion can be used in well remediation, stimulation and hydrogen sulfide mitigation operations.

U.S. Pat. No. 8,323,417 teaches a method of treatment for inhibiting sulfur-based corrosion or scaling or for removing scaling from a surface including inhibiting corrosion caused by sulfur-containing materials, reducing corrosion caused by sulfur-containing materials, inhibiting scaling caused by sulfur-containing materials in gas, liquid or solid phase or any combination of multiple phases of materials, reducing scaling caused by sulfur-containing materials, and removing scaling caused by sulfur-containing materials. The method involves contacting sulfur-containing materials with a composition containing a turpentine liquid, wherein said turpentine liquid comprises α-terpineol, β-terpineol, β-pinene, and p-cymene.

US patent application no. 2006/0264335 A1 discloses an aqueous organic acid composition containing a terpene as corrosion inhibitor intensifier is especially suitable for use in acidizing subterranean formations and wellbores. The composition substantially reduces the corrosive effects of the acidic solution on metals in contact with the acidic solution. Suitable terpenes are said to include carotene, limonene, pinene, farnesene, camphor, cymene and menthol.

U.S. Pat. No. 5,674,823 discloses novel derivatives of terpene origin which consist of cycloalkenyls or cycloalkyls having at least seven carbon atoms and possessing surfactant and/or fragrant properties. According to one embodiment, the invention relates to compounds of characteristic formula I in which p and q are integers or decimal numbers and are not equal to zero, O<P<20, preferably, O<P<5, and O<q<100, preferably 1<q<20. It is stated that the invention has particular applicability in detergent and perfume formulations.

Despite the various known corrosion inhibition packages, there is still a need for corrosion inhibition packages for use with modified and synthetic acid compositions in the oil industry which can be used over a range of applications, that are specifically formulated for synthetic and modified acid systems and can be used at ultra-high temperatures (i.e. 150° C.) without having its components degrade, phase out of solution and have a superior safety and environmental profile over known packages during use at those ultra-high temperatures.

### SUMMARY OF THE INVENTION

According to a first aspect of the present invention, there is provided a corrosion inhibition package for use with an aqueous acid composition, said package comprising:
a thiourea organic derivative;
a propargyl alcohol or derivative thereof;
at least one amphoteric surfactant;
optionally, a tall oil fatty acid;
at least one non-ionic surfactant; and
a solvent.

Preferably, the thiourea organic derivative is a polymer comprising monomers formed of units comprising: a thiourea moiety with a formaldehyde moiety and a 1-phenylethanone moiety. Such a polymer is generated by a Mannich reaction (condensation) where the three moieties are reacted and form a single molecule.

Preferably, the mixture of unsaturated fatty acids (tall oil) contains a combination of oleic acid, linoleic acid, stearic acid and others.

Preferably, the at least one amphoteric surfactant is selected from the group consisting of: a sultaine surfactant; a betaine surfactant; and combinations thereof. More preferably, the sultaine surfactant and betaine surfactant are selected from the group consisting of: an amido betaine surfactant; an amido sultaine surfactant; and combinations thereof. Yet even more preferably, the amido betaine surfactant and is selected from the group consisting of: an amido betaine comprising a hydrophobic tail from C₈ to C₁₆. Most preferably, the amido betaine comprising a hydrophobic tail from C₈ to C₁₆ is cocamidobetaine.

Preferably also, the corrosion inhibition package further comprises an non-ionic surfactant.

Preferably, one of the non-ionic surfactants is a group consisting of a 4-Nonylphenol branched, ethoxylated moiety. More preferably, the non-ionic surfactant is selected from the group comprising a mixture of repeating ethoxy (oxy-1,2-ethanediyl) groups. Even more preferably the non-ionic surfactant is selected from a group containing nine repeating ethoxy groups.

Preferably, one of the non-ionic surfactants is a group consisting of a linear ethoxylated alcohol. More preferably, the non-ionic surfactant is selected from a group containing three repeating ethoxy groups.

Preferably, the solvent is selected from the group consisting of: propylene glycol; methanol; ethanol; isopropanol; ethylene glycol; Di-n-hexyl-ether; and 2-Butoxyethanol; and combinations thereof.

Preferably, the thiourea organic derivative is present in an amount ranging from 2% to 20% by weight of the total weight of the corrosion inhibition package. Preferably also, the propargyl alcohol or derivative thereof is present in an amount ranging from 2% to 30% by volume of the total weight of the corrosion inhibition package. Preferably also, the unsaturated acids is present in an amount ranging from 1% to 10% by volume of the total weight of the corrosion inhibition package. Preferably also, the at least one surfactant is present in an amount ranging from 2% to 30% by volume of the total weight of the corrosion inhibition package. Preferably also, the solvent is present in an amount ranging from 15% to 35% by volume of the total weight of the corrosion inhibition package.

According to another aspect of the present invention, there is provided an acidic composition comprising:
an acid;
a corrosion package comprising:
a thiourea organic derivative;
a propargyl alcohol or derivative thereof;
optionally, a tall oil fatty acid;
at least one surfactant; and
a solvent;

wherein the volume % of the corrosion package in the acidic composition ranges from 0.1 to 10%. Preferably, the acidic composition further comprises an intensifier selected from the group consisting of: metal iodide or iodate and formic acid.

Preferably the weight/volume % of the metal iodide or iodate in the acidic composition ranges from 0.1 to 5%. More preferably, the wt/vol. % of the metal iodide or iodate in the acidic composition ranges from 0.25 to 1.25%. Even more preferably, the wt/vol. % of the metal iodide or iodate in the acidic composition is approximately 1%. Preferably, the metal iodide or iodate selected from the group consisting of: cuprous iodide; potassium iodide; sodium iodide; lithium iodide and combinations thereof. More preferably, the metal iodide is potassium iodide.

Preferably the weight/volume % of the formic acid in the acidic composition ranges from 0.1 to 15%. More preferably, the wt/vol. % of the formic acid in the acidic composition ranges from 0.25 to 10%. Even more preferably, the wt/vol. % of the formic acid in the acidic composition is approximately 5%.

According to one aspect of the present invention, there is provided an acidic composition comprising a corrosion inhibition package according to the invention and an acid selected from the group consisting of: mineral acids; organic acids, synthetic acids; and combinations thereof. More preferably, the acid is selected from the group consisting of: HCl, Lysine-HCl, Urea-HCl, hydrofluoric acid, sulfuric acid, phosphoric acid, p-toluene sulfonic acid. Even more preferably, the acid is lysine-HCl.

According to a preferred embodiment of the present invention, the corrosion inhibition package is used with an acidic composition such as a modified acid composition comprising:
a strong acid and an alkanolamine in a molar ratio of not more than 15:1; preferably in a molar ratio not more than 10:1, more preferably in a molar of not more than 8:1; even more preferably in a molar ratio of not more than 5:1; yet even more preferably in a molar ratio of not more than 3.5:1; and yet even more preferably in a molar ratio of not more than 2.5:1.

According to an aspect of the present invention, there is provided an aqueous synthetic acid composition for use in onshore oil and gas operations, said composition comprising: monoethanolamine and hydrochloric acid in a molar ratio of not less than 1:12; a surfactant; a corrosion inhibitor; and an intensifier.

According to an aspect of the present invention, there is provided an aqueous synthetic acid composition for use in offshore oil and gas operations, said composition comprising: monoethanolamine and hydrochloric acid in a molar ratio of not less than 1:12; a corrosion inhibitor; and an intensifier.

The use of a corrosion inhibitor package with an acidic composition where the acidic composition comprises an acid selected from the group consisting of: a mineral acid; an organic acid or a synthetic acid, said corrosion inhibitor package comprising:
a thiourea organic derivative;
a propargyl alcohol or derivative thereof;
at least one amphoteric surfactant;
optionally, a tall oil fatty acid;
at least one non-ionic surfactant; and
a solvent.

According to another aspect of the present invention, there is provided a use of a synthetic or modified acid composition comprising a preferred embodiment of the present invention in the oil and gas industry to perform an activity selected from the group consisting of: stimulating formations; assisting in reducing breakdown pressures during downhole pumping operations; treating wellbore filter cake post drilling operations; assisting in freeing stuck pipe; descaling pipelines and/or production wells; increasing injectivity of injection wells; lowering the pH of a fluid; fracturing wells; performing matrix stimulations; conducting annular and bullhead squeezes & soaks; pickling tubing, pipe and/or coiled tubing; increasing effective permeability of formations; reducing or removing wellbore damage; cleaning perforations, nozzles, ports, jets etc.; solubilizing limestone, dolomite, and calcite; and removing undesirable scale from the group consisting of: equipment, cyclical steam wells, steam flood wells, SAGD (steam assisted gravity drainage) wells, unassisted or natural high formation temperature production wells, injection wells and their related surface and down-hole equipment and facilities at high temperatures up to 180° C.

According to another aspect of the present invention, there is provided a synthetic or modified acid composition comprising a corrosion inhibition package according to a preferred embodiment for use in the oil and gas industry which has high salinity tolerance. A tolerance for high salinity fluids, or brines, is desirable for onshore and offshore acid applications. Conventional acids are normally blended with fresh water and additives, typically far offsite, and then transported to the area of treatment as a finished blend. It is advantageous to have an alternative that can be transported as a concentrate safely to the treatment area, then blended with a saline produced water or sea water. This greatly reduces logistics requirement. A conventional acid composition can precipitate salts/minerals heavily if blended with fluids of an excessive saline level resulting in formation plugging or ancillary damage, inhibiting production and substantially increasing costs. Brines are also typically present in formations, thus having an acidic composition system that has a high tolerance for brines greatly reduces the potential for formation damage or emulsions forming down-hole during or after product placement/spending (reaction) occurs.

A preferred embodiment of the present invention provides a corrosion inhibition package which provides various oilfield grade steel alloys exceptional protection against corrosion when exposed to acidic compositions at low to ultra-high temperatures.

### DETAILED DESCRIPTION OF THE PREFERRED EMBODIMENTS

The description that follows, and the embodiments described therein, is provided by way of illustration of an example, or examples, of particular embodiments of the principles of the present invention. These examples are provided for the purposes of explanation, and not limitation, of those principles and of the invention.

According to an aspect of the invention, there is provided a corrosion inhibition package for use with an acidic composition, said corrosion inhibition package comprising:
a thiourea organic derivative;
a propargyl alcohol or derivative thereof;
optionally, a tall oil fatty acid;
at least one amphoteric surfactant;
at least one non-ionic surfactant; and
a solvent.

According to preferred embodiment of the present invention, there is provided a corrosion inhibition package for use with an acidic composition, said corrosion inhibition package comprising:
a thiourea organic derivative;
a propargyl alcohol or derivative thereof;
a tall oil fatty acid;
at least one amphoteric surfactant;
at least one non-ionic surfactant; and
a solvent.

Preferably, the corrosion inhibition package is used with an acidic composition such as a synthetic acid composition comprising:
lysine & hydrogen chloride in a molar ratio of not less than 1:12; preferably in a molar ratio not less than 1:8, more preferably in a molar ratio of not less than 1:5, even more preferably in a molar ratio of not less than 1:3 and even more preferably in a molar ratio of not less than 1:2.5.

Preferably, when the synthetic or modified acid composition comprises lysine and hydrogen chloride, the molar ratio of lysine to HCl can range from 1:2 to 1:12; preferably in a molar ratio ranging from 1:2.5 to 1:8, more preferably in a molar ratio ranging from 1:3 to 1:6, even more preferably in a molar ratio ranging from 1:3 to 1:5.

Also, preferably, the corrosion inhibition package is used with an acidic composition such as a modified acid composition comprising:
a strong acid and an alkanolamine in a molar ratio of not more than 15:1; preferably in a molar ratio not more than 10:1, more preferably in a molar of not more than 8:1; even more preferably in a molar ratio of not more than 5:1; yet even more preferably in a molar ratio of not more than 3.5:1; and yet even more preferably in a molar ratio of not more than 2.5:1. Preferably, the composition comprises an alkanolamine and a strong acid, such as HCl, nitric acid, sulfuric acid, sulfonic acid. The alkanolamine according to the present invention contains at least one amino group, —NH2, and one alcohol group, —OH. Preferred alkanolamines include, but are not limited to, monoethanolamine, diethanolamine, and triethanolamine.

Alcohols and derivatives thereof, such as alkyne alcohols and derivatives and preferably propargyl alcohol and derivatives thereof can be used as corrosion inhibitors. Propargyl alcohol itself is traditionally used as a corrosion inhibitor which works well at low concentrations. It is however a very toxic/flammable chemical to handle as a concentrate, so care must be taken when exposed to the concentrate. In the composition according to the present invention, it is preferred to use 2-Propyn-1-ol, complexed with methyloxirane, as this is a much safer derivative to handle. Basocorr® PP is an example of a propargyl alcohol derivative as it is a propoxylated propagyl alcohol. In preferred embodiments of the present invention, 2-Propyn-1-ol, complexed with methyloxirane is present in an amount ranging from 2% to 30% by volume of the total volume of the corrosion inhibition package.

Preferably, the at least one amphoteric surfactant is selected from the group consisting of: a sultaine surfactant; a betaine surfactant; and combinations thereof. More preferably, the sultaine surfactant and betaine surfactant are selected from the group consisting of: an amido betaine surfactant; an amido sultaine surfactant; and combinations thereof. Yet even more preferably, the amido betaine surfactant and is selected from the group consisting of: an amido betaine comprising a hydrophobic tail from C₈ to C₁₆. Most preferably, the amido betaine comprising a hydrophobic tail from C₈ to C₁₆ is cocamidobetaine.

According to a preferred embodiment of the present invention, when preparing an acidic composition comprising a corrosion inhibition package, metal iodides or iodates such as potassium iodide, sodium iodide, cuprous iodide and lithium iodide can be added as corrosion inhibitor intensifier. The iodide or iodate is preferably present in a weight/volume percentage ranging from 0.1 to 1.5%, more preferably from 0.25 to 1.25%, yet even more preferably 1% by weight/volume of the acidic composition. Most preferably, the iodide used is potassium iodide.

According to a preferred embodiment of the present invention, the corrosion package comprises: 2-Propyn-1-ol, compd. with methyloxirane; cocamidopropyl betaine; thiourea organic derivative; formic acid; 4-Nonylphenol branched, ethoxylated; tall oil fatty acid; a three mole ethoxylated alcohol and propylene glycol. More preferably, the composition comprises 20% of 2-Propyn-1-ol, compd. with methyloxirane; 10% thiourea organic derivative; 5% Tall oil fatty acids; 5% Formic acid; 0.5% nonaethylene glycol nonylphenyl ether; 30% of cocamidopropyl betaine; 8% of a three mole ethoxylated alcohol; and 21.5% of propylene glycol (all percentages are volume percentages).

### Example 1—Process to Prepare an Acidic Composition Comprising a Corrosion Inhibition Package According to a Preferred Embodiment of the Invention

Monoethanolamine is used as starting reagent. To obtain a 1:4 molar ratio of MEA to HCl, 38.15 ml of 99 wt % monoethanolamine solution and 237 ml HCl aq. 36% (22 Baume) were combined. The corrosion inhibition package, and potassium iodide (if required) are added at this point. Circulation is maintained until all products have been solubilized. Additional products can now be added as required.

The resulting composition of Example 1 is an straw-colored liquid having an expected shelf-life of greater than a three months. It has a freezing point temperature of approximately minus 45° C. and a boiling point temperature of approximately 100° C. It has a specific gravity of 1.15±0.02. It is completely soluble in water and its pH is less than 1.

According to a preferred embodiment of the present invention, the corrosion inhibition package is prepared by dispersing a thiourea organic derivative in propylene glycol, 2-Propyn-1-ol, compd with methyloxirane, formic acid, and three selected surfactants. Afterwards, the corrosion inhibition package thus prepared is mixed with an acidic composition.

According to a preferred embodiment of the present invention, the thiourea organic derivative is a polymer comprising monomers formed of units comprising: a thiourea moiety with a formaldehyde moiety and a 1-phenylethanone moiety. Such a polymer is generated by a Mannich reaction (condensation) where the three moieties are reacted and form a single molecule. Preferably, the polymer has the following CAS number 68527-49-1.

According to a preferred embodiment of the present invention, the thiourea organic derivative is present in the corrosion inhibition package in an amount ranging from 2 to 20 wt %. More preferably, the thiourea organic derivative is present in an amount ranging from 6 to 15 wt. %. More preferably, the thiourea organic derivative is present in an amount ranging from 8 to 12 wt. %.

According to a preferred embodiment of the present invention, tall oil fatty acid is present in the corrosion inhibition package in an amount ranging from 1 to 10 wt %.

According to a preferred embodiment of the present invention, 4-Nonylphenol branched, ethoxylated is present in the corrosion inhibition package in an amount ranging from 10 to 3 wt %.

According to a preferred embodiment of the present invention, linear ethoxylated alcohol is present in the corrosion inhibition package in an amount ranging from 1 to 10 wt %.

According to a preferred embodiment of the present invention, water is present in the corrosion inhibition package in an amount ranging from 10 to 25 wt %.

According to a preferred embodiment of the present invention, Cocamido Propyl Betaine is present in the corrosion inhibition package in an amount ranging from 10 to 30 wt %.

According to a preferred embodiment of the present invention, formic acid is present in the corrosion inhibition package in an amount ranging from 5 to 10 wt %.

According to a preferred embodiment of the present invention, 2-Propyn-1-ol, compd. with methyloxirane is present in the corrosion inhibition package in an amount ranging from 5 to 20 wt %.

According to a preferred embodiment of the present invention, propylene glycol is present in the corrosion inhibition package in an amount ranging from 10 to 25 wt %.

With respect to the corrosion impact of the acidic composition on typical oilfield grade steel alloys, it was established that it was clearly well below the acceptable corrosion limits set by industry making it highly desirable as corrosion is the main challenge during acid applications causing substantial maintenance and workover costs over time.

### Corrosion Inhibition Package Formulations

Various types of steel alloy coupons were subjected to corrosion testing in the presence of synthetic and modified acid compositions using a corrosion inhibitor package according to a preferred embodiment of the present invention at a temperature of 90° C. The results of the corrosion tests are reported in Table 2. The control used was a composition of HCl without any corrosion inhibition additives. Coupons of various grades of steel alloys (indicated in each table) were exposed to the control composition and a similar acid composition containing the corrosion inhibition package of example 1 for a period of six hours.

TABLE 1
List of Components and Content in the Corrosion
Inhibition Package of Example 1

| Component | CI-1 |
|---|---|
| 2-Propyn-1-ol, compd. with methyloxirane | 20 |
| Thiourea organic derivative | 10 |
| Cocamidopropyl betaine | 30 |
| Nonaethylene glycol nonylphenyl ether | 0.5 |
| Propylene Glycol | 21.5 |
| Formic Acid | 5 |
| Ethoxylate alcohol | 8 |
| Tall Oil Fatty Acid | 5 |
| Total vol. % | 100 |

### Corrosion Testing

A desirable result was one where the lb/ft² corrosion number is at or below 0.05. More preferably, that number is at or below 0.02.

TABLE &num;2:
Corrosion test results from tests conducted on multiple
alloys at 90° C. for a period of 6 hours

| | Acid | | | CI | | | | | Weight |
|---|---|---|---|---|---|---|---|---|---|
| Corrosion | Strength | Temp | Duration | Loading | Weight Loss (lbs/ft²) | | | | Loss (%) |
| Inhibitor | (%) | (° C.) | (hr) | (%) | L-80 | J-55 | P-110 | QT-800 | Wireline |
| No CI | 15 | 90 | 6 | 0 | 0.795 | 0.733 | 0.581 | 0.310 | 83.0 |
| CI-1 | 15 | 90 | 6 | 0.75 | 0.003 | 0.004 | 0.004 | 0.003 | 2.07 |

The above corrosion testing results validate the effectiveness of a composition according to a preferred embodiment of the present invention.

Additionally, corrosion inhibition packages according to preferred embodiments of the present invention will allow the end user to utilize synthetic and modified acids that have the down-hole performance advantages, transportation, and storage advantages as well as the health, safety and environmental advantages. The person skilled in the art will also understand that the corrosion package according to the present invention is useful when as also utilized with conventional acid systems.

In addition to stability at high temperatures and desirable corrosion rates as discussed above, the use of synthetic and modified acids along with a corrosion package according to a preferred embodiment of the present invention, allows for reduction in skin corrosiveness, a more controlled or methodical spending or reacting property, minimizing near well bore damage typically caused by an ultra-aggressive reaction with the formation typically caused by HCl and increasing formation penetration providing superior production over time.

### Uses of Corrosion Inhibition Packages According to Preferred Embodiments of the Present Invention

The uses (or applications) of the corrosion inhibition packages according to the present invention when combined (or mixed) with acidic compositions upon dilution of the latter ranging from approximately 1 to 90% dilution, include, but are not limited to: injection/disposal well treatments; matrix acid squeezes, soaks or bullheads; acid fracturing, acid washes; fracturing spearheads (breakdowns); pipeline scale treatments, cement breakdowns or perforation cleaning; pH control; and de-scaling applications. As would be understood by the person skilled in the art, the methods of use generally comprise the following steps: providing a composition comprising a corrosion inhibitor package according to a preferred embodiment of the present; mixing said package with an acid composition; exposing a surface (such as a metal surface) to the acid composition comprising the package; allowing the acid composition a sufficient period of time to act upon said surface; and optionally, removing the acid composition when the exposure time has been determined to be sufficient for the operation to be complete or sufficiently complete. Another method of use comprises: injecting the acid composition comprising the package into a well and allowing sufficient time for the acid composition to perform its desired function. Yet another method of use comprises: exposing the acid composition comprising the package to a body of fluid (typically water) requiring a decrease in the pH and allowing sufficient exposure time for the acid composition to lower the pH to the desired level.

One of the advantages of the use of a synthetic acid composition using a corrosion inhibition package according to a preferred embodiment of the present invention includes: the reduction of the total loads of acid, and the required number of tanks by delivering concentrated product to location and diluting with fluids available on location (with low to high salinity production water).

While the foregoing invention has been described in some detail for purposes of clarity and understanding, it will be appreciated by those skilled in the relevant arts, once they have been made familiar with this disclosure that various changes in form and detail can be made without departing from the true scope of the invention in the appended claims.

1. A corrosion inhibition package for use with an aqueous acid composition, said package comprising:
a thiourea organic derivative;
a propargyl alcohol or derivative thereof;
optionally, a tall oil fatty acid;
at least one amphoteric surfactant;
at least one non-ionic surfactant; and
at least one solvent.

2. The corrosion inhibition package as claimed in claim 1, wherein the thiourea organic derivative is a polymer comprising monomers selected from the group consisting of: a thiourea moiety; a formaldehyde moiety; and a 1-phenylethanone moiety, and wherein each one of said monomers are combined together and undergo a Mannich condensation reaction to form said polymer to generate said polymer.

3. The corrosion inhibition package as claimed in claim 1, wherein the at least one amphoteric surfactant is selected from the group consisting of: a sultaine surfactant; a betaine surfactant; and combinations thereof.

4. The corrosion inhibition package as claimed in claim 3, wherein the sultaine surfactant and betaine surfactant are selected from the group consisting of: an amido betaine surfactant; an amido sultaine surfactant; and combinations thereof.

5. The corrosion inhibition package as claimed in claim 4, wherein the amido betaine surfactant and is selected from the group consisting of: an amido betaine comprising a hydrophobic tail from C₈ to C₁₆.

6. The corrosion inhibition package as claimed in claim 5, wherein the amido betaine surfactant comprising a hydrophobic tail from C₈ to C₁₆ is cocamidobetaine.

7. The corrosion inhibition package as claimed in claim 1, wherein the non-ionic surfactant is a 4-Nonylphenol branched, ethoxylated moiety.

8. The corrosion inhibition package as claimed in claim 7, wherein the non-ionic surfactant comprises a mixture of repeating ethoxy (Oxy-1,2-ethanediyl) groups.

9. The corrosion inhibition package as claimed in claim 8, wherein the non-ionic surfactant is Tergitol NP-9.

10. The corrosion inhibition package as claimed in claim 1, wherein the solvent is selected from the group consisting of: propylene glycol; isopropanol; methanol; ethanol; 2-butoxyethanol; diethylene glycol; Di-n-hexyl-ether; and combinations thereof.

11. The corrosion inhibition package as claimed in claim 1, wherein the thiourea organic derivative is present in an amount ranging from 2% to 15% by volume of the total volume of the corrosion inhibition package.

12. The corrosion inhibition package as claimed in claim 1, wherein the propargyl alcohol or derivative thereof is present in an amount ranging from 2% to 30% by volume of the total volume of the corrosion inhibition package.

13. The corrosion inhibition package as claimed in claim 1, wherein the at least one surfactant is present in an amount ranging from 2% to 30% by volume of the total volume of the corrosion inhibition package.

14. The corrosion inhibition package as claimed in claim 1, wherein the solvent is present in an amount ranging from 5% to 30% by volume of the total volume of the corrosion inhibition package.

15. An aqueous liquid acidic composition, comprising:
an acidic solution;
a corrosion package comprising:
a thiourea organic derivative
a propargyl alcohol or derivative thereof;
optionally, a tall oil fatty acid;
an amphoteric surfactant;
a non-ionic surfactant; and
a solvent;
wherein the volume % of the corrosion package in the acidic composition ranges from 0.1 to 10%.

16. The composition according to claim 15, further comprising a metal iodide or iodate.

17. The composition according to claim 16, wherein the volume % of the metal iodide or iodate in the acidic composition ranges from 0.1 to 5%.

18. The composition according to claim 15, wherein the acid is selected from the group consisting of: mineral acids; organic acids, synthetic acids; modified acids; complexed acids and combinations thereof.

19. The composition according to claim 15, wherein the acid solution is selected from the group consisting of: HCl, Lysine-HCl, Urea-HCl, hydrofluoric acid, sulfuric acid, phosphoric acid, p-toluene sulfonic acid.

20. The composition according to claim 15, wherein the metal iodide or iodate selected from the group consisting of: cuprous iodide; potassium iodide; sodium iodide; lithium iodide and combinations thereof.
